(19) United States
(12) Patent Application Publication
(10) Pub. No.: US 2013/0167955 A1
(43) Pub. Date: Jul. 4, 2013

(54) Vented Fan Duct

(71) Applicant: Bryan S. Claerhout, Hesston, KS (US)

(72) Inventor: Bryan S. Claerhout, Hesston, KS (US)

(73) Assignee: AGCO Corporation, Duluth, GA (US)

(21) Appl. No.: 13/338,287

(22) Filed: Dec. 28, 2011

(51) Int. Cl. F15D 1/00

(52) U.S. Cl. 137/561 R

(57) ABSTRACT

A duct may be disclosed. The duct may comprise a first wall and a second wall. The first wall and the second wall in combination may define a passage, an inlet, and an outlet. The inlet and the outlet may be in fluid communication with the passage. The second wall may define at least one opening in fluid communication with the passage.

### CROSS-REFERENCE TO RELATED APPLICATIONS

The current application is related to U.S. patent application Ser. No. ______ filed on Dec. 28, 2011, entitled “Multiple Fan Blade Angles in a Single Crossflow Fan,” (Attorney Docket No. A1220H) and U.S. patent application Ser. No. ______ filed on Dec. 28, 2011, entitled “Adjusting Air Flow without Restricting a Fan,” (Attorney Docket No. A1226H), which are hereby incorporated by reference in its entirety.

### BACKGROUND

Equipment such as, for example, agricultural machines, may have a fan. The fan may be used to create airflow. The airflow may be used for various purposes such as, for example, cleaning and cooling equipment parts. The fan may be internal or external.

### BRIEF DESCRIPTION OF THE DRAWINGS

The accompanying drawings, which are incorporated in and constitute a part of this disclosure, illustrate various embodiments of the disclosure. In the drawings:

FIG. 1 is a diagram of a combine;

FIG. 2 is a diagram of a fan assembly; and

FIG. 3 is a diagram of a duct.

### DETAILED DESCRIPTION

### Overview

A duct may comprise a first wall and a second wall. The first wall and the second wall in combination may define a passage, an inlet, and an outlet. The inlet and the outlet may be in fluid communication with the passage. The second wall may define at least one opening in fluid communication with the passage.

Both the foregoing general description and the following detailed description are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the detailed description.

### Example Embodiments

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

A fan may be connected to a duct. The fan may produce an airstream. The air stream may have a constant velocity, but a non-uniform flow. To achieve a more uniform flow, at least one hole may be located in at least one of the walls forming the duct.

While this disclosure describes ducts that may direct airflows in the context of a combine, embodiments are not limited to agricultural environment. In other words, applications where a varying airflow pattern may be desirable include not only agricultural equipment, but also include, for example, industrial and manufacturing applications.

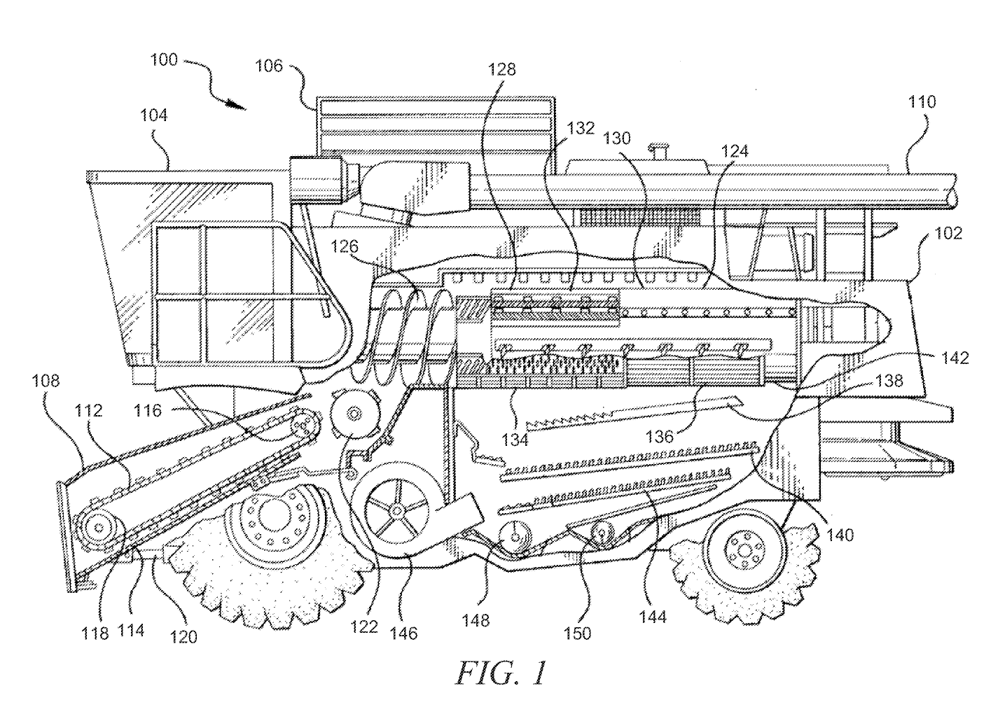

FIG. 1 is a diagram of a combine 100. Combine 100 may comprise a separator housing 102, an operator's work station and cab 104, a grain tank 106, and an elevator assembly 108. A swingable unloading auger assembly 110 may pivot to a position extending laterally outward to one side of combine 100 to unload grain tank 106. Unloading auger assembly 110 may swing inward to a storage position as shown in FIG. 1 when grain tank 106 is not being unloaded.

Elevator assembly 108 may have a conveyor 112 mounted in an elevator housing 114. Conveyor 112 may be trained around rear drive sprockets 116 and a front drum 118. Hydraulic linear actuators 120 may pivot elevator housing 114 to raise and lower the forward end of elevator housing 114.

Crop material may be fed to a feed beater 122 by conveyor 112 in elevator housing 114. Feed beater 122 may feed crop material to a separating rotor 124. Separating rotor 124 may comprise a feed section 126, a threshing section 128, and a separation section 130. Feed section 126 may move crop material in a spiral path about a generally horizontal fore and aft axis of rotation to separating rotor 124, toward threshing section 128. In threshing section 128, crop material may pass between a cylinder bar 132 and a concave 134 where grain may be threshed. Threshed grain, that is not separated by concave 134, may be separated in separation section 130 and may pass through a separation grate 136. A grain pan 138 may convey grain and chaff forward and may deposit it on a chaffer 140. Crop material other than grain (MOG) may be discharged from separating rotor 124 through a rotor discharge 142.

Grain and MOG that may pass through concave 134 and separation grate 136 may fall to upper grain pan 138. Grain pan 138 may convey grain and chaff forward and may deposit it on chaffer 140. The grain may be cleaned by chaffer 140 and a sieve 144 and air from a fan assembly 146. Chaff may be discharged from the rear of sieve 144 and chaffer 140. Clean grain may fall into a clean grain auger 148. The clean grain may be conveyed to grain tank 106 by clean grain auger 148 and an elevator (not shown). Tailings may fall into a returns auger 150 and may be conveyed to separating rotor 124 by returns auger and return elevators (not shown), where they may be threshed a second time.

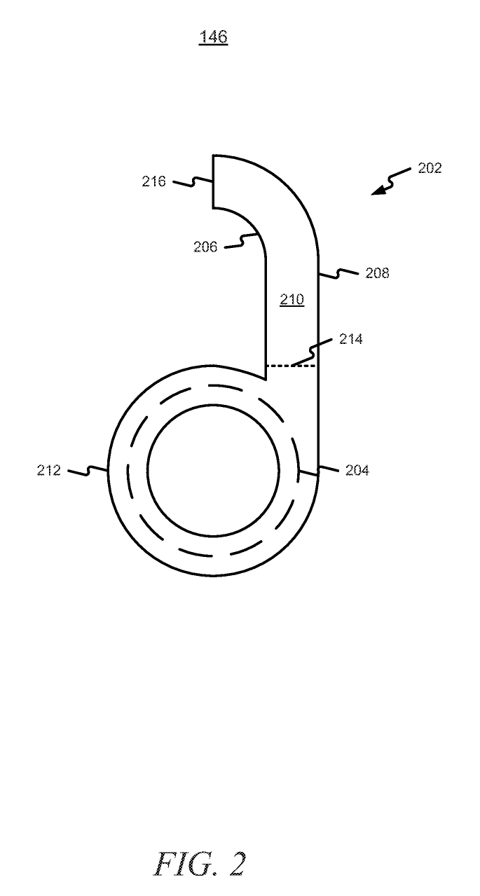

FIG. 2 is a diagram of a fan assembly 146. Fan assembly 146 may comprise a duct 202 and a fan 204. Duct 202 may comprise a first wall 206 and a second wall 208. First wall 206 and second wall 208 may define a passage 210. Fan 204 may be located in cavity 212. Passage 210 may be in fluid communication with an inlet 214 and an outlet 216. Outlet 216 may be arranged to allow a fluid (e.g., air) to be at least partially directed toward sieve 144.

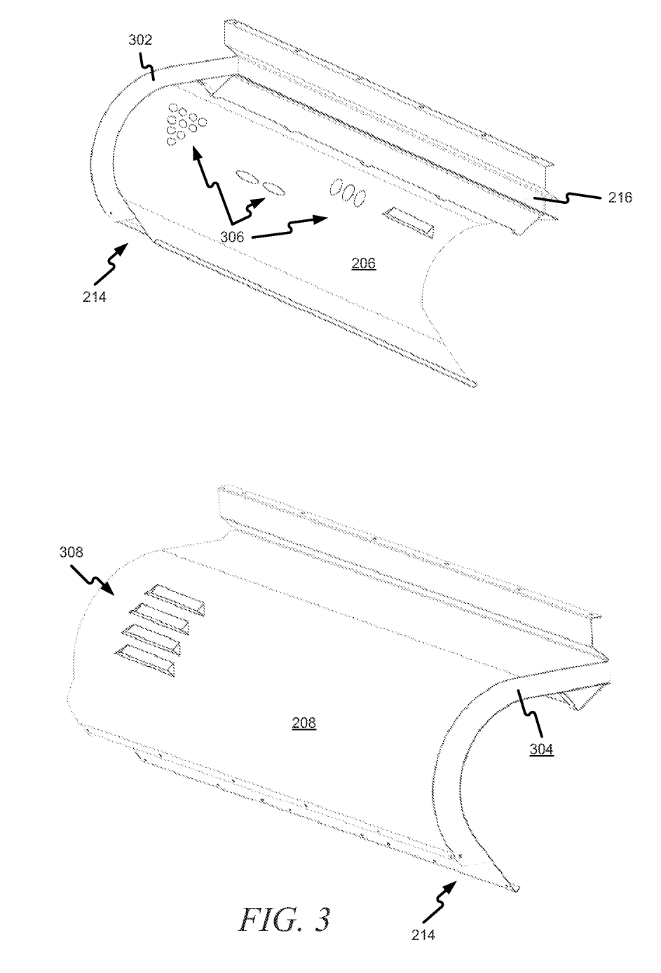

FIG. 3 is diagram of duct 202. In addition, to first wall 206 and second wall 208, duct 202 may comprise a first side wall 302 and a second side wall 304. First wall 206 may comprise one or more holes 306. Second wall 208 may comprise one or more holes (not shown). The one or more holes located in second wall 208 may be covered by one or more louvers 308 located on or proximate second wall 208. While FIGS. 2 and 3 show duct 202 being rectangular, duct 202 may comprise any shape such as, for example, circular, triangular, and hexagonal.

During operation, a fluid (e.g., air) may flow through inlet 214, traverse passage 210, and exit outlet 216. As the fluid traverses passage 210, fluid external to passage 210 may be drawn into one or more holes 306 located on first wall 206. In addition, to being drawn into one or more holes 306, a portion of the fluid traversing passage 210 may be expelled from passage 210 via one or more holes 306. While not shown in FIG. 3, one or more louvers 308 may be located on or proximate first wall 206. The one or more louvers 308 may be used to help control the rate fluid enters or exits one or more holes 306.

Furthermore, during operation the fluid traversing passage 210 may a portion of the fluid may be expelled from passage 210 via the one or more holes located on second wall 208. In addition, fluid may be drawing into passage 210 via the one or more holes located in second wall 208. One or more louvers 308 may be located on or proximate second wall 208 and may be used to regulate the fluid being drawn into or expelled from passage 210. For example, one or more louvers may be arranged to partially block the one or more openings located in second wall 208.

Embodiments of duct 202 may also comprise configurations of one or more holes 306 and the one or more holes located in second wall 208 where the fluid both flows into and out of passage 210 at the same time. For example, during operation, as the fluid traverses passage 210, a portion of the fluid may be expelled from the one or more holes located in second wall 208, while at the same time, fluid may be drawn into passage 210 via one or more holes 306. Furthermore, one or more holes 306 may be arranged in first wall 206 such that fluid may be expelled from passage 210 and drawn into passage 210 by one or more holes 306. For instance, a portion of one or more holes 306 may be located proximate inlet 214 such that the fluid may be drawn into passage 210. Another portion of one or more holes 306 may be located proximate a curved portion of first wall 206 such that fluid may be expelled from passage 210. Similar arrangements for the one or more holes located in second wall 208 may be implemented as well.

First wall 206 and/or second wall 208 may comprise a curved portioned (e.g., a concave or convex portion). One or more holes 306 and the one or more holes located in second wall 208 may be located within or proximate the curved portions. For example, one or more holes 306 or the one or more holes located in second wall 208 may be located proximate a beginning portion of the curved portion (e.g., proximate inlet 214). In addition, one or more holes 306 or the one or more holes located in second wall 208 may be located proximate a tailing portion of the curved portion (e.g., proximate outlet 216).

An embodiment may comprise an apparatus. The apparatus may comprise a first wall and a second wall. The first wall and the second wall in combination may define a passage, an inlet, and an outlet. The inlet and the outlet may be in fluid communication with the passage. The second wall may define at least one opening in fluid communication with the passage.

Another embodiment may comprise an apparatus. The apparatus may comprise a combine having a sieve and a duct arranged to direct a gas at least partially toward the sieve. The duct may comprise a first wall and a second wall. The first wall and the second wall in combination may define a passage, an inlet, and an outlet. The inlet and the outlet may be in fluid communication with the passage. The second wall may define at least one opening in fluid communication with the passage.

Yet another embodiment may comprise a method. The method may comprise: causing a fluid to traverse a passage; and increasing or decreasing a flow rate of the fluid upon by drawing an additional amount of the fluid into or forcing a portion of the fluid from the passage.

Both the foregoing general description and the following detailed description are examples and explanatory only, and should not be considered to restrict the invention's scope, as described and claimed. Further, features and/or variations may be provided in addition to those set forth herein. For example, embodiments may be directed to various feature combinations and sub-combinations described herein.

All rights, including copyrights, in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example embodiments.

What is claimed is:

1. An apparatus comprising:
a first wall; and
a second wall, the first wall and the second wall in combination defining a passage, an inlet in fluid communication with the passage, and an outlet in fluid communication with the passage, the second wall defining at least one opening in fluid communication with the passage.

2. The apparatus of claim 1, wherein the second wall comprises a curved portion located between the inlet and the outlet, the at least one opening being defined within the curved portion.

3. The apparatus of claim 2, wherein the at least one opening is defined proximate a beginning portion of the curved portion.

4. The apparatus of claim 2, wherein the at least one opening is defined proximate a tailing portion of the curved portion.

5. The apparatus of claim 1, further comprising at least one louver located proximate the at least one opening.

6. The apparatus of claim 5, wherein the at least one louver is configured to cause air external to the passage to be drawn into the passage.

7. The apparatus of claim 5, wherein the at least one louver is configured to partially block the opening.

8. The apparatus of claim 1, wherein the at least one opening is located on a concaved portion of the second wall.

9. The apparatus of claim 1,
wherein the at least one opening is located on a convex portion of the second wall, and
further comprising at least one louver located proximate the at least one opening.

10. An apparatus comprising:
a combine having a sieve;
a first wall; and
a second wall, the first wall and the second wall in combination defining a passage, an inlet in fluid communication with the passage, and an outlet in fluid communication with the passage the outlet arranged to direct a gas at least partially toward the sieve, the second wall defining at least one opening in fluid communication with the passage.

11. The apparatus of claim 10, wherein the second wall comprises a curved portion located between the inlet and the outlet, the at least one opening being defined within the curved portion.

12. The apparatus of claim 11, wherein the at least one opening is defined proximate a beginning portion of the curved portion.

13. The apparatus of claim 11, wherein the at least one opening is defined proximate a tailing portion of the curved portion.

14. The apparatus of claim 10, further comprising at least one louver located proximate the at least one opening.

15. The apparatus of claim 14, wherein the at least one louver is configured to cause air external to the passage to be drawn into the passage.

16. The apparatus of claim 14, wherein the at least one louver is configured to partially block the opening.

17. The apparatus of claim 10, wherein the at least one opening is located on a concaved portion of the second wall.

18. The apparatus of claim 10,
wherein the at least one opening is located on a convex portion of the second wall, and
further comprising at least one louver located proximate the at least one opening.

19. A method comprising:
causing a fluid to traverse a passage; and
increasing or decreasing a flow rate of the fluid upon by drawing an additional amount of the fluid into or forcing a portion of the fluid from the passage.

20. The method of claim 19, wherein drawing the additional amount of fluid into the passage further comprises drawing the additional amount of the fluid through a least one louver.
